(19) United States
(12) Patent Application Publication
(10) Pub. No.: US 2025/0187535 A1
(43) Pub. Date: Jun. 12, 2025

(54) PROCESSING SYSTEM, PROCESSING DEVICE,AUTONOMOUS DRIVING DEVICE, PROCESSING METHOD, AND STORAGE MEDIUM STORING PROCESSING PROGRAM

(71) Applicant: DENSO CORPORATION, Kariya-city (JP)

(72) Inventor: SHUNSUKE MOCHIZUKI, Kariya-city (JP)

(21) Appl. No.: 19/047,281

(22) Filed: Feb. 6, 2025

Related U.S. Application Data
(63) Continuation of application No. PCT/JP2023/026401, filed on Jul. 19, 2023.

(30) Foreign Application Priority Data
Aug. 8, 2022 (JP) 2022-126521

(51) Int. Cl. B60Q 1/50; B60W 60/00; F21S 43/00; F21W 103/60; G08G 1/01

(52) U.S. Cl. CPC B60Q 1/547; B60W 60/001; F21S 43/601; F21W 2103/60; G08G 1/0141

(57) ABSTRACT

A processing system for performing processing regarding autonomous driving of an autonomous driving device is provided. The processing system includes a processor configured to obtain a planned driving route of the autonomous driving device, and project a notification image onto a road along the planned driving route. The notification image includes a boundary image that indicates a boundary of a moving allowable area where an other road user is allowed to move, the boundary facing a driving area where the autonomous driving device travels, and a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

### CROSS REFERENCE TO RELATED APPLICATIONS

The present application is a continuation application of International Patent Application No. PCT/JP2023/026401 filed on Jul. 19, 2023, which designated the U.S. and claims the benefit of priority from Japanese Patent Application No. 2022-126521 filed on Aug. 8, 2022. The entire disclosures of all of the above applications are incorporated herein by reference.

### TECHNICAL FIELD

This disclosure relates to a technique for performing processing related to autonomous driving of an autonomous driving device.

### BACKGROUND

There is a technique in which, when other moving objects are detected in the surrounding area of own vehicle, an image is projected on the road surface near the other moving objects.

### SUMMARY

According to the first aspect of the present disclosure, a processing system for performing processing regarding autonomous driving of an autonomous driving device is provided. The processing system includes a processor configured to obtain a planned driving route of the autonomous driving device, and project a notification image onto a road along the planned driving route. The notification image includes a boundary image that indicates a boundary of a moving allowable area where an other road user is allowed to move. The boundary faces a driving area (Rd) where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the second aspect of the present disclosure, a processing device to be mounted in an autonomous driving device for performing processing regarding autonomous driving of the autonomous driving device is provided. The processing device includes a processor configured to obtain a planned driving route of the autonomous driving device, and project a notification image onto a road along the planned driving route. The notification image includes a boundary image (lb) that indicates a boundary of a moving allowable area where an other road user is allowed to move. The boundary faces a driving area where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the third aspect of the present disclosure, an autonomous driving device including the processing device according to the second aspect is provided. The processing device executes processing regarding autonomous driving.

According to the fourth aspect of the present disclosure, a processing method executed by a processor for performing processing regarding autonomous driving of an autonomous driving device is provided. The processing method includes obtaining a planned driving route of the autonomous driving device, and projecting a includes a boundary image that indicates a boundary of a moving allowable area where an other road user is allowed to move. The boundary faces a driving area where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the fifth aspect of the present disclosure, a non-transitory computer readable storage medium storing a processing program for performing processing regarding autonomous driving of an autonomous driving device is provided. The processing program includes instructions when executed by a processor cause the processor to obtain a planned driving route of the autonomous driving device, and project a notification image onto a road along the planned driving route. The notification image includes a boundary image that indicates a boundary of a moving allowable area where an other road user is allowed to move. The boundary faces a driving area where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

### BRIEF DESCRIPTION OF THE DRAWINGS

FIG. 1 is a block diagram illustrating the overall configuration of a processing system according to a first embodiment.

FIG. 2 is a schematic diagram for explaining a driving state of an autonomous driving device to which the processing system according to the first embodiment is applied.

FIG. 3 is a schematic diagram illustrating the autonomous driving device to which the processing system according to the first embodiment is applied.

FIG. 4 is a block diagram illustrating the autonomous driving device to which the processing system according to the first embodiment is applied.

FIG. 5 is a block diagram illustrating the functional configuration of the processing system according to the first embodiment.

FIG. 6 is a flowchart illustrating a processing procedure according to the first embodiment.

FIG. 7 is a schematic diagram for explaining the processing procedure according to the first embodiment.

FIG. 8 is a schematic diagram for explaining the processing procedure according to the first embodiment.

FIG. 9 is a schematic diagram for explaining the processing procedure according to the first embodiment.

FIG. 10 is a schematic diagram for explaining the processing procedure according to the first embodiment.

FIG. 11 is a schematic diagram for explaining the processing procedure according to the first embodiment.

FIG. 12 is a schematic diagram for explaining the processing procedure according to the first embodiment.

FIG. 13 is a flowchart illustrating a processing procedure according to a second embodiment.

FIG. 14 is a schematic diagram for explaining the processing procedure according to the second embodiment.

### DETAILED DESCRIPTION OF THE PREFERRED EMBODIMENTS

To begin with, examples of relevant techniques will be described.

There is a technique in which, when other moving objects are detected in the surrounding area of own vehicle, an image is projected on the road surface near the other moving objects.

However, when the technology is applied to an autonomous driving device, it is difficult to notify other moving objects of future actions of the autonomous driving device. Thus, it is difficult for the other moving object to feel reassured about the future actions of the autonomous driving device.

It is objective of the present disclosure to provide a processing system that can provide a sense of reassurance about future actions of an autonomous driving device. It is another objective of the present disclosure to provide a processing device that can provide a sense of reassurance about future actions of an autonomous driving device and the autonomous driving device including the processing device. It is yet another objective of the present disclosure to provide a processing method that can provide a sense of reassurance about future actions of an autonomous driving device. It is yet another objective of the present disclosure to provide a storage medium including a processing program that can provide a sense of reassurance about future actions of an autonomous driving device.

Hereinafter, technical means of the present disclosure for solving the problems will be described.

According to the first aspect of the present disclosure, a processing system for performing processing regarding autonomous driving of an autonomous driving device is provided. The processing system includes a processor configured to obtain a planned driving route of the autonomous driving device, and project a notification image onto a road along the planned driving route. The notification image includes a boundary image that indicates a boundary of a moving allowable area where an other road user is allowed to move. The boundary faces a driving area (Rd) where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the second aspect of the present disclosure, a processing device to be mounted in an autonomous driving device for performing processing regarding autonomous driving of the autonomous driving device is provided. The processing device includes a processor configured to obtain a planned driving route of the autonomous driving device, and project a notification image onto a road along the planned driving route. The notification image includes a boundary image (lb) that indicates a boundary of a moving allowable area where an other road user is allowed to move. The boundary faces a driving area where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the third aspect of the present disclosure, an autonomous driving device including the processing device according to the second aspect is provided. The processing device executes processing regarding autonomous driving.

According to the fourth aspect of the present disclosure, a processing method executed by a processor for performing processing regarding autonomous driving of an autonomous driving device is provided. The processing method includes obtaining a planned driving route of the autonomous driving device, and projecting a includes a boundary image that indicates a boundary of a moving allowable area where an other road user is allowed to move. The boundary faces a driving area where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the fifth aspect of the present disclosure, a non-transitory computer readable storage medium storing a processing program for performing processing regarding autonomous driving of an autonomous driving device is provided. The processing program includes instructions when executed by a processor cause the processor to obtain a planned driving route of the autonomous driving device, and project a notification image onto a road along the planned driving route. The notification image includes a boundary image that indicates a boundary of a moving allowable area where an other road user is allowed to move. The boundary faces a driving area where the autonomous driving device travels according to the planned driving route. The notification image further includes a trajectory image that indicates a planned trajectory, as the driving area, that the autonomous driving device follows according to the planned driving route. The boundary image is located outside the trajectory image in a width direction of the road. The boundary image has different display modes depending on a distance from the autonomous driving device on the planned driving route.

According to the first to fifth aspects described above, a planned driving route of the autonomous driving device is acquired. The notification image is projected on the driving road along the planned driving route. The notification image includes a boundary image that indicates the boundary of a moving allowable area where an other road user is allowed to move. The moving allowable area faces a driving area where the autonomous driving device travels according to the planned driving route. Thus, the other road user can recognize, from the notification image including the boundary image, not only the driving area where the autonomous driving device plans to travel but also the moving allowable area where the other road user is allowed to move based on actions of the autonomous driving device within the driving area. Thus, it is possible for the other road user to feel reassured about future actions of the autonomous driving device.

Hereinafter, embodiments of the present disclosure will be described with reference to the drawings. It should be noted that the same reference numerals are assigned to corresponding components in the respective embodiments, and overlapping descriptions may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the multiple embodiments can be partially combined together even if the configurations are not explicitly described under a condition that there is no difficulty in the combination in particular.

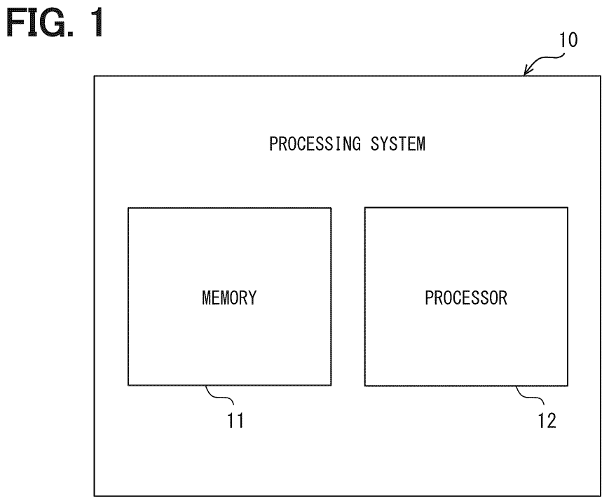

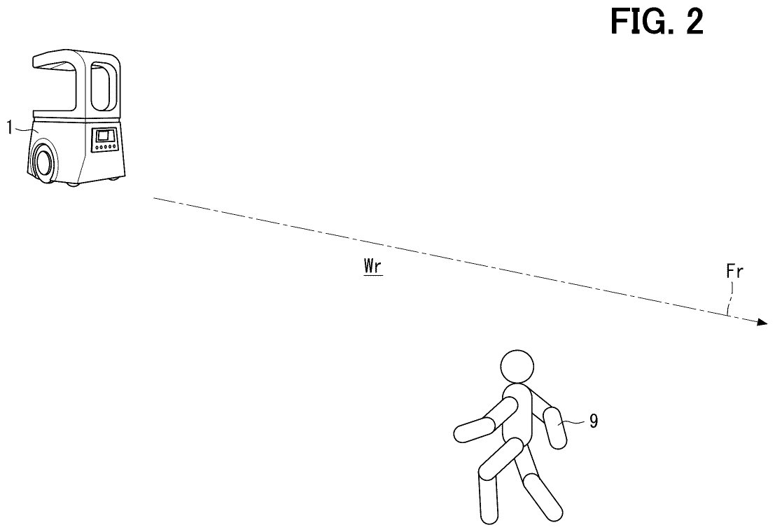

(First Embodiment) A processing system 10 of a first embodiment depicted in FIG. 1 performs processing regarding autonomous driving of an autonomous driving device 1 depicted in FIG. 2 (hereinafter, referred to as an autonomous driving-related process). In particular, the autonomous driving-related process of the present embodiment includes at least a notification process regarding notification from the autonomous driving device 1 to an other road user 9. Here, the other road user 9 for the autonomous driving device 1 is a road user other than the autonomous driving device 1 that exists in the external environment in which the autonomous driving device 1 travels. The other road user 9 includes, for example, non-vulnerable road users such as cars, trucks, motorcycles, and bicycles, and vulnerable road users such as pedestrians.

The autonomous driving device 1 is configured to drive autonomously in any direction of the front, back, left and right. The autonomous driving device 1 may be a delivery vehicle that autonomously travels on a road and transports packages to the delivery destination. The autonomous driving device 1 may be a logistics vehicle that autonomously travels through a warehouse to transport packages. The autonomous driving device 1 may be a disaster support robot that autonomously travels around a disaster area to transport supplies or collect information. The autonomous driving device 1 may be of a category other than those described above. Further, any type of the autonomous driving device 1 may autonomously travel by receiving remote driving assist or driving control from an external center.

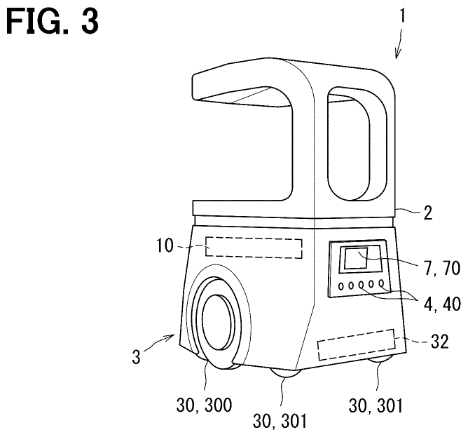

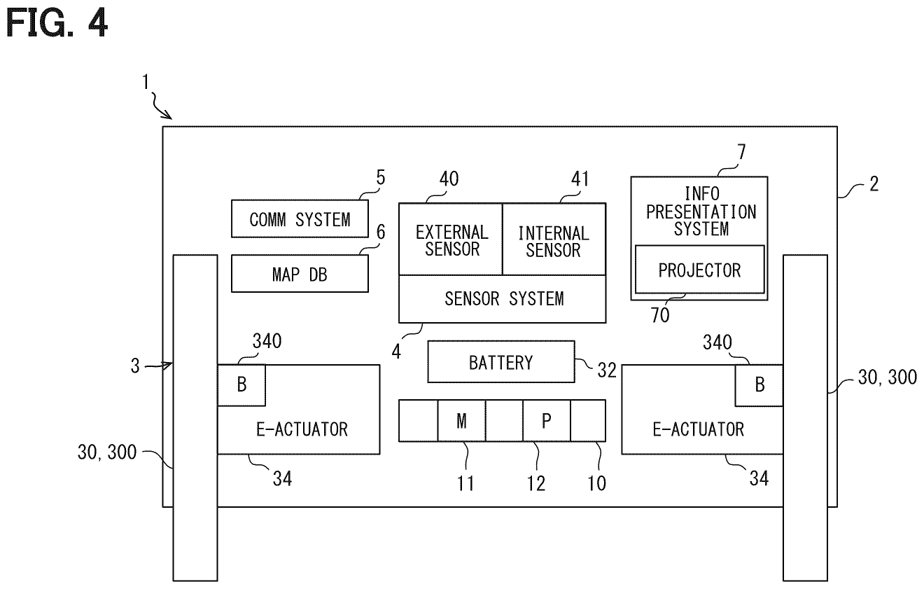

Specifically, as shown in FIGS. 3 and 4, the autonomous driving device 1 includes a body 2, a drive system 3, a sensor system 4, a communication system 5, a map database 6, and an information presentation system 7. The body 2 has a hollow shape, which is made of metal, for example. The body 2 holds other components of the autonomous driving device 1 inside or across the body 2.

The drive system 3 has wheels 30, a battery 32, and electric actuators 34. The wheels 30 are supported by the body 2. Each of the wheels 30 is rotatable independently. The wheels 30 include drive wheels 300 that are provided respectively to the left portion and the right portion of the body 2, and the drive wheels 300 are independently driven by the electric actuators 34 provided respectively for the drive wheels 300. In the present embodiment, the rotation speed difference (that is, the rotation speed difference per unit time) between the drive wheels 300 determines whether the autonomous driving device 1 travels straight or turns.

Specifically, the autonomous driving device 1 travels straight when the rotation speed difference between the right and left drive wheels 300 is zero or substantially zero. On the other hand, the autonomous driving device 1 turns when the rotation speed difference between the right and left drive wheels 300 increases. The greater the rotation speed difference, the less the turning radius of the autonomous driving device 1 is. Here, the turning radius means the distance between the vertical center line of the body 2 and the center of the turning in a planar view. The turning of the autonomous driving device 1 is a point turning when the turning radius is substantially zero. Here, the wheels 30 may include at least one driven wheel that rotates following the drive wheels 300.

The battery 32 is installed in the body 2. The battery 32 is mainly composed of a storage battery such as a lithium-ion battery, for example. The battery 32 stores electric power by charging from an external device and supplies the electric power to electric components in the autonomous driving device 1 by discharging. The battery 32 may store regenerated electric power from the electric actuators 34. The battery 32 is electrically connected to the electric actuators 34, the sensor system 4, the communication system 5, the map database 6, the information presentation system 7 and at least one portion of a processing system 10 installed in the autonomous driving device 1, which will be described later, through wire harnesses.

The electric actuators 34 are separately installed in the body 2 as a pair as shown in FIG. 4. Each of the electric actuators 34 is mainly composed of an individual electric motor. Each of the electric actuators 34 rotates the corresponding drive wheel 300 independently. Each of the electric actuators 34 includes a brake unit 340 that applies braking to the corresponding drive wheel 300 during rotation. Each of the electric actuators 34 may further include a lock unit that locks the corresponding drive wheel 300 while stopped.

The sensor system 4 shown in FIGS. 3 and 4 acquires sensing information available for the processing system 10 by sensing the external environment and the internal environment of the autonomous driving device 1. For this purpose, the components of the sensor system 4 are mounted at various locations on the body 2. Specifically, the sensor system 4 has at least one external sensor 40 and at least one internal sensor 41.

The external sensor 40 acquires external environment information as sensing information from the external environment that is the surrounding environment of the autonomous driving device 1. The external sensor 40 may be of an object detection type, which detects an object existing in the external environment of the autonomous driving device 1. The external sensor 40 of the object detection type is at least one of a camera, a Light Detection and Ranging/Laser Imaging Detection and Ranging (LiDAR), a radar, sonar, and the like, for example. The external sensor 40 may be of an environment detection type, which detects a specific environmental physical quantity in the external environment of the autonomous driving device 1. The external sensor 40 of the environment detection type is, for example, an illuminance sensor.

The internal sensor 41 as shown in FIG. 4 acquires internal environment information as sensing information from the internal environment of the autonomous driving device 1. The internal sensor 41 may be of a physical quantity-detecting type which detects a specific physical quantity of motion in the internal environment of the autonomous driving device 1. The internal sensor 41 of the physical quantity detection type is at least one of a driving speed sensor, an acceleration sensor, an yaw-rate sensor, and the like.

The communication system 5 exchanges communication information available for the processing system 10 and the outside of the processing system 10 through wireless communication between the external environment and the autonomous driving device 1. The communication system 5 includes a V2X type communication system that exchanges communication signals with a V2X system located outside the autonomous driving device 1. The communication system 5 of the V2X type may be at least one of a dedicated short range communications (i.e., DSRC) communication device, a cellular V2X (i.e., C-V2X) communication device, or the like.

The communication system 5 may have a positioning type system that receives positioning signals from an artificial satellite of a global navigation satellite system (GNSS) located outside the autonomous driving device 1. The external sensor 40 of positioning type is, for example, a GNSS receiver or the like. The communication system 5 may have a terminal communication type communication system that exchanges communication information with a mobile terminal existing in the external environment of the autonomous driving device 1. For example, the communication system 5 of the terminal communication type may be at least one of a Bluetooth (registered trademark) device, a Wi-Fi (registered trademark) device, an infrared communication device, or the like.

The map database 6 stores map information available for the processing system 10. The map database 6 includes at least one non-transitory tangible storage medium, such as a semiconductor memory, a magnetic medium, and an optical medium. The map database 6 may be a database of a locator that estimates self-state quantities including the self-position of the autonomous driving device 1. The map database 6 may be a database of a planning unit that plans the driving of the autonomous driving device 1. The map database 6 may be configured by combining various types of these databases.

The map database 6 acquires and stores the latest map information as one piece of the communication information received from the external center through the communication system 5. It is preferable that the map information is converted into two-dimensional or three-dimensional data as information indicating the driving environment of the autonomous driving device 1. The map information may include road information indicating at least one of a position, a shape, and a surface condition of a road. The map information may include marking information indicating at least one of a traffic sign, a lane mark position, and a lane mark shape associated with a road. The map information may include structure information indicating at least one of positions and shapes of a building and a traffic light along a road.

The information presentation system 7 shown in FIGS. 3 and 4 presents notification information from the autonomous driving device 1 to the other road user 9 as the notification processing in the autonomous driving-related processing. The information presentation system 7 has at least a projector unit 70 as a visual stimulation type presentation system for presenting notification information by stimulating the vision of a human such as a pedestrian as the other road user 9 and/or the vision of a human in the other road user 9.

The body 2 has at least one of the projector unit 70. The projector unit 70 is mainly composed of an image projector. The projector unit 70 achieves projection mapping by aligning and projecting an image onto a driving path Wr (see FIG. 2), which is a road where the autonomous driving device 1 travels. The projector unit 70 has the shortest projection distance set to 1 m from the autonomous driving device 1 in a forward direction, for example. The projector unit 70 has the longest projection distance set to 5 m from the autonomous driving device 1 in the forward direction, for example.

In addition to the projector unit 70, the information presentation system 7 may have another type of projector unit, such as a monitor unit and a light-emitting unit as a visual stimulation type. The information presentation system 7 may present notification information by stimulating the hearing of a human such as a pedestrian as the other road user 9 and/or the hearing of a human in the other road user 9. The information presentation system 7 that stimulates the hearing may be at least one of a speaker, a buzzer, and a vibration unit.

The processing system 10 which controls the autonomous driving device 1 is mainly composed of at least one dedicated computer including a computer mounted in the body 2. The dedicated computer constituting the processing system 10 is connected to the battery 32, the electric actuators 34, the sensor system 4, the communication system 5, the map database 6, and the information presentation system 7 through at least one of Local Area Network (LAN), a wire harness, an inner bus, a wireless communication line and the like.

The dedicated computer constituting the processing system 10 may be a planning Electronic Control Unit (ECU) that plans a target trajectory for the autonomous driving device 1. The dedicated computer constituting the processing system 10 may be a trajectory control ECU that causes the actual trajectory of the autonomous driving device 1 to follow the target trajectory. The dedicated computer constituting the processing system 10 may be an actuator ECU that controls the electric actuators 34 of the autonomous driving device 1.

The dedicated computer constituting the processing system 10 may be a sensing ECU that controls the sensor system 4 of the autonomous driving device 1. The dedicated computer constituting the processing system 10 may be a locator ECU that estimates self-state quantities including the self-position of the autonomous driving device 1 based on the map database 6. The dedicated computer constituting the processing system 10 may be an information presentation ECU that controls the information presentation system 7 of the autonomous driving device 1. The dedicated computer constituting the processing system 10 may be at least one external computer that constructs an external center or a mobile terminal capable of communicating via, for example, the communication system 5.

The dedicated computer constituting the processing system 10 as shown in FIG. 4 includes at least one memory 11 and at least one processor 12. The memory 11 is at least one type of non-transitory tangible storage medium, such as a semiconductor memory, a magnetic medium, and an optical medium, for storing, in non-transitory manner, computer readable programs and data. The processor 12 includes, as a core, at least one type of, for example, a CPU (Central Processing Unit), a GPU (Graphics Processing Unit), an RISC (Reduced Instruction Set Computer)-CPU, and so on.

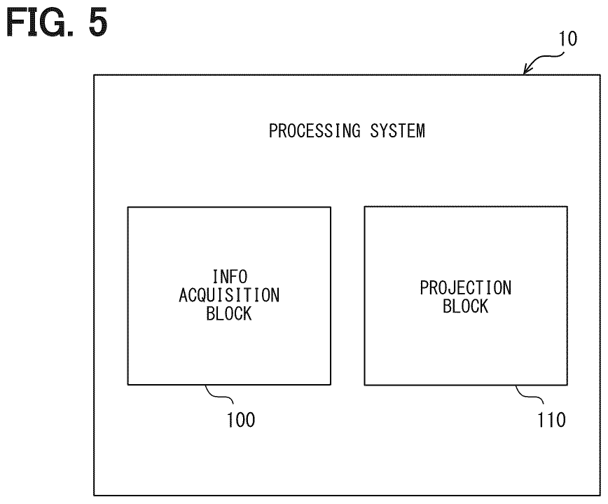

In the processing system 10, the processor 12 executes multiple instructions included in a control program stored in the memory 11 in order to perform autonomous driving-related processing of the autonomous driving device 1. Accordingly, the processing system 10 constructs multiple functional blocks for performing the autonomous driving-related processing. The multiple functional blocks built in the processing system 10 include an information acquisition block 100 and a projection block 110 as shown in FIG. 5.

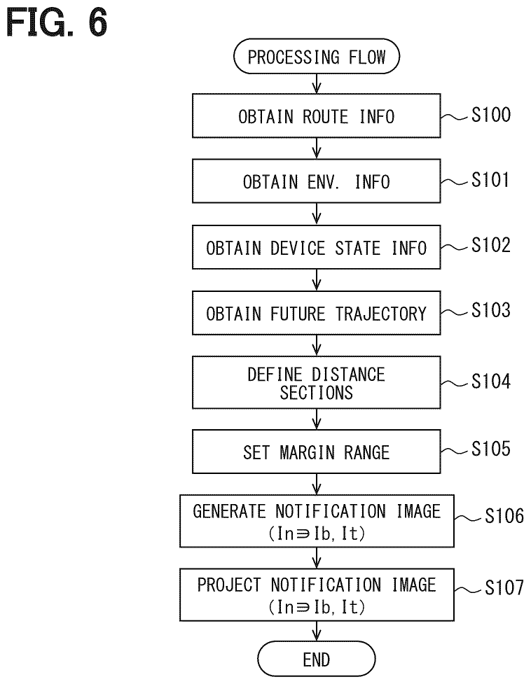

With the cooperation of these blocks 100 and 110, a processing method for the processing system 10 to perform the autonomous driving-related processing is executed according to the processing flow shown in FIG. 6. The processing flow is repeatedly executed while the autonomous driving device 1 is activated. Each “S” in the processing flow means a corresponding one of steps executed according to instructions included in the processing program.

In the S100, the information acquisition block 100 acquires route information as a driving plan along the planned driving route on which the autonomous driving device 1 plans to travel as shown in FIG. 2. The route information may be acquired as one piece of the communication information received from the external center through the communication system 5. The route information may be planned by the information acquisition block 100 based on communication information received from the external center through the communication system 5. It is preferable that the route information includes point planning information such as a destination and a waypoint to cause the autonomous driving device 1 to autonomously drive to the destination. It is preferable that the route information includes planned trajectory information that indicates a planned trajectory followed by the autonomous driving device 1 according to the point planning information.

In the processing flow shown in FIG. 6, S101 is executed after S100. In S101, the information acquisition block 100 acquires environmental information about the external environment on the planned driving route Fr represented by the route information acquired in S100. Environmental information is acquired based on various types of information such as sensing information by the external sensor 40, communication information received from the external center through the communication system 5, and map information of the map database 6. The environmental information includes at least road surface information of the driving road Wr on the planned driving route Fr, which extends from the current position of the autonomous driving device 1 to the longest projection distance of the projector unit 70 as shown in FIG. 2. Here, the road surface information of the driving road Wr may be at least one of flatness information of the road surface, brightness information of the road surface, and friction coefficient information of the road surface. In addition to the road surface information, the environmental information may include at least one of stationary object information on the planned driving route Fr, weather information on the planned driving route Fr, or traffic information on the planned driving route Fr.

In the processing flow shown in FIG. 6, S102 is executed in parallel with S101 or before or after S101 (FIG. 6 shows an example where S102 is executed after S101). In S102, the information acquisition block 100 acquires state information of the autonomous driving device 1 at the current position. The state information is acquired based on the sensing information by the internal sensor 41. The state information should include at least one motion information such as speed, acceleration, or yaw rate of the autonomous driving device 1. The state information may include charging information representing the charging state of the battery 32. The state information may include deterioration information of at least one of the battery 32 or the electric actuators 34.

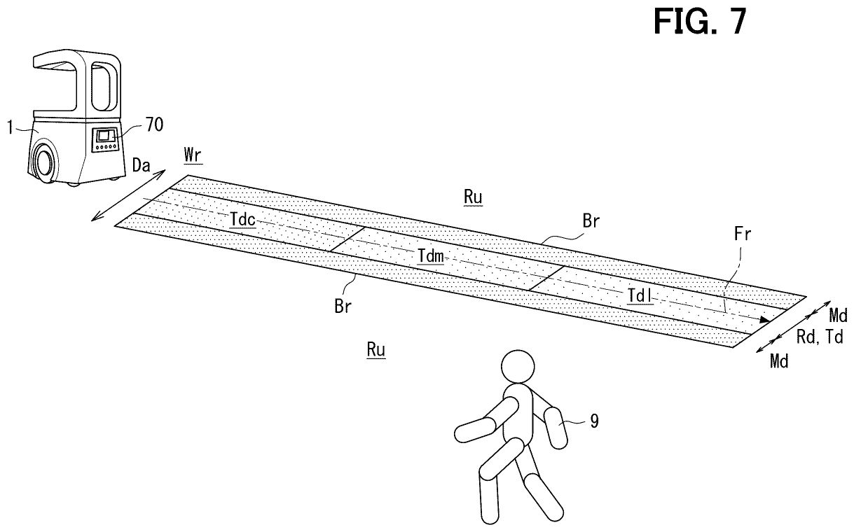

In the processing flow after execution of S101 and S102, S103 shown in FIG. 6 is executed. In S103, the information acquisition block 100 acquires a planned trajectory Td to determine a driving area Rd of the autonomous driving device 1 according to the planned driving route Fr, which is represented by the route information acquired in S100, as shown in FIG. 7. The planned trajectory Td is acquired as an ideal driving area Rd to be followed by the autonomous driving device 1 according to the planned driving route Fr. The planned trajectory Td is acquired based on the planned trajectory information among the route information.

In the processing flow shown in FIG. 6, S104 is executed after S103. In S104, the information acquisition block 100 defines distance sections Tdl, Tdm, and Tdc as shown in FIG. 7 in the planned trajectory Td that is acquired in S103. The distance sections Tdl, Tdm, and Tdc are determined according to the distance from the autonomous driving device 1 along the planned driving route Fr.

Specifically, the distance sections include a long-distance section Tdl, a medium-distance section Tdm, and a short-distance section Tdc. The long-distance section Tdl is defined to be a range in which the driving plan along the planned driving route Fr can be changed in response to the other road user 9 entering the planned trajectory Td, which is the ideal driving area along the driving plan. In other words, the long-distance section Tdl is set to the range along the planned driving route Fr in which the autonomous driving device1 can avoid the other road user 9 entering the planned trajectory Td by changing the driving plan along the planned driving route Fr. However, the long-distance section Tdl in the present embodiment is limited to the range up to the longest projection distance of the projector unit 70 among the range in which the driving plan is changeable (i.e., changeable distance range). The long-distance section Tdl is variably adjusted to the optimal changeable distance range that is determined based on at least one type of information acquired from S100 through S103. In addition, the change of the driving plan in the long-distance section Tdl may be a change of the planned driving plan Fr including a temporary change of a driving direction or a change of the driving speed.

The medium-distance section Tdm is defined to a range in which the autonomous driving device 1 can brake with the brake unit 340 in response to the other road user 9 entering the planned trajectory Td within the driving area Rd, so that the autonomous driving device 1 can avoid the other road user 9. In other words, the medium-distance section Tdm is set to the range along the planned driving route Fr in which the autonomous driving device 1 can avoid the other road user 9 entering the planned trajectory Td by braking on the planned driving route Fr. However, the medium-distance section Tdm in the present embodiment is set to the range in which the autonomous driving device 1 can brake (i.e., braking distance range) excluding the long-distance section Tdl. Thus, the medium-distance section Tdm is closer to the autonomous driving device 1 than the long-distance section Tdl is. The medium-distance section Tdm is variably adjusted to the optimal braking distance range that is determined based on at least one type of information acquired from S100 through S103.

The short-distance section Tdc is defined as a range that is too close to the autonomous driving device 1 for the other road user 9 entering the planned trajectory Td, which is the driving area Rd. The short-distance section Tdc in the present embodiment is set to a range from the shortest projection range to the longest projection range of the projector unit 70 excluding the long-distance section Tdl and the medium-distance section Tdm. In other words, the short-distance section Tdc is the range along the planned driving route Fr that is closer to the autonomous driving device 1 than the long-distance section Tdl and the medium-distance section Tdm are. The short-distance section Tdc is variably adjusted to a range corresponding to the long-distance section Tdl and the medium-distance section Tdm.

In the processing flow shown in FIG. 6, S105 is executed in parallel with S104 or before or after S104 (FIG. 6 shows an example where S105 is executed after S104). In S105, the information acquisition block 100 sets a margin range Md for the driving area Rd (i.e., the planned trajectory Td acquired in S103) of the autonomous driving device 1 as shown in FIG. 7. The margin range Md is a variable range in which the ideal planned trajectory Td according to the driving plan may fluctuate in the width direction Da of the driving road Wr on the planned driving route Fr. The trajectory may be fluctuate by a change in the behavior of the autonomous driving device 1, which is caused by disturbances from the external environment. The margin range Md is set for each side of the planned trajectory in the width direction Da of the driving road Wr. The margin range Md may be constant in two or all of the long-distance section Tdl, the medium-distance section Tdm, and the short-distance section Tdc. The margin range Md may be different among the long-distance section Tdl, the medium-distance section Tdm, and the short-distance section Tdc in the planned trajectory Td.

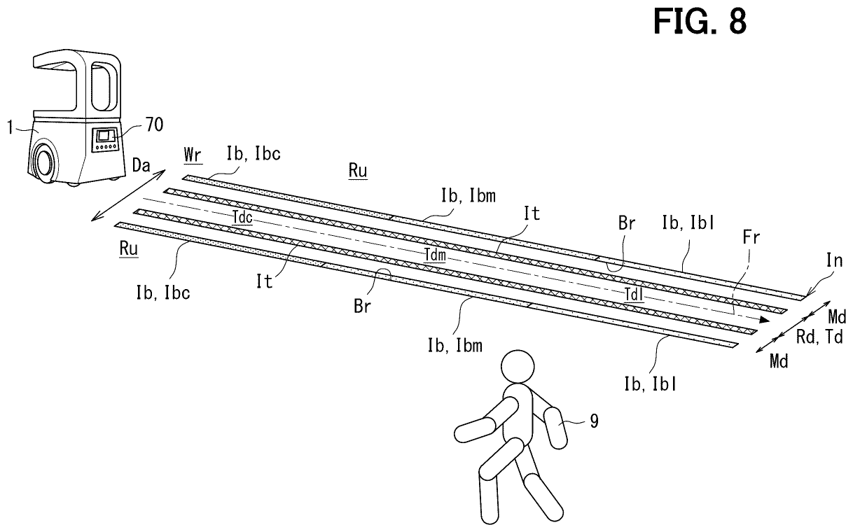

In the processing flow, S106 shown in FIG. 6 is executed after S104 and S105. In S106, the projection block 110 generates a notification image In for projection onto the driving road Wr along the planned driving route Fr, as shown in FIGS. 8 to 12, to achieve a notification to the other road user 9. The notification image In includes a boundary image Ib as shown in FIGS. 8 to 12. The boundary image indicates a boundary Br (or a limit) of a moving allowable area Ru where the other road user 9 is allowed to move. The boundary Br faces the driving area Rd of the autonomous driving device 1 along the planned driving route as shown in FIG. 7. The notification image In further includes a trajectory image It as shown in FIGS. 8 to 12. The trajectory image indicates the ideal planned trajectory according to the driving plan, as the driving area Rd which serves as a reference for the boundary Br of the moving allowable area Ru.

Specifically, the notification image In is generated such that the boundary image Ib is displayed on the boundary Br between the margin range Md acquired in S105 and the moving allowable area Ru. The boundary image Ib is displayed on each side of the trajectory image It, which indicates the planned trajectory Td acquired in S103, in the width direction Da. This means that the boundary Br is aligned at a position spaced from each of side ends of the planned trajectory Td in the width direction Da by the margin range Md. This means that the moving allowable area Ru is a range outward of the boundary Br of the margin range Md in the width direction Da away from the planned trajectory Td. However, the moving allowable area Ru is limited to a range of the road (i.e., the driving road Wr on the planned driving route Fr) in the width direction Da.

The boundary image Ib is created as an image of two lines spaced respectively from both sides of the trajectory image It by the margin range Md in the width direction Da. The image of two lines is projected to extend along the planned driving route Fr. Further, the boundary image Ib includes distance images Ibl, Ibm, and Ibc respectively representing the distance sections Tdl, Tdm, and Tdc acquired in S104. The distance images Ibl, Ibm, and Ibc sandwiches the distance sections Tdl, Tdm, and Tdc in the width direction Da, respectively. The distance images Ibl, Ibm, and Ibc are identified by a change in display color according to the distance from the autonomous driving device 1, as per the display modes. It should be noted that in FIGS. 8 to 12, the distance images Ibl, Ibm, and Ibc are schematically represented by differences in hatching types.

Here, the long-distance image Ibl is disposed at both sides of the long-distance section Tdl and indicates the long-distance section Tdl by a color, such as blue that indicates the long-distance. The medium-distance image Ibm is disposed at both sides of the medium-distance section Tdm and indicates the medium-distance section Tdm by a color, such as yellow which indicates the medium-distance and attracts more than the color that indicates the long-distance. The short-distance image Ibc is disposed at both sides of the short-distance area Tdc and indicates the short-distance area Tdc by a color such as red that indicates the short-distance and attracts more than the colors that indicate the long-distance and the medium distance.

The width in the width direction Da of each line of the boundary image, which includes the distance images Ibl, Ibm, and Ibc, may be substantially constant in the direction along the planned driving route Fr. The width in the width direction Da of each line of the boundary image Ib, which includes the distance images Ibl, Ibm, and Ibc, may increase stepwise or continuously as the flatness of the road surface of the driving road Wr decreases on the planned driving route Fr. The width in the width direction Da of each line of the boundary image Ib, which includes the distance images Ibl, Ibm, and Ibc, may increase stepwise or continuously as the brightness of the road surface of the driving road Wr decreases on the planned driving route Fr.

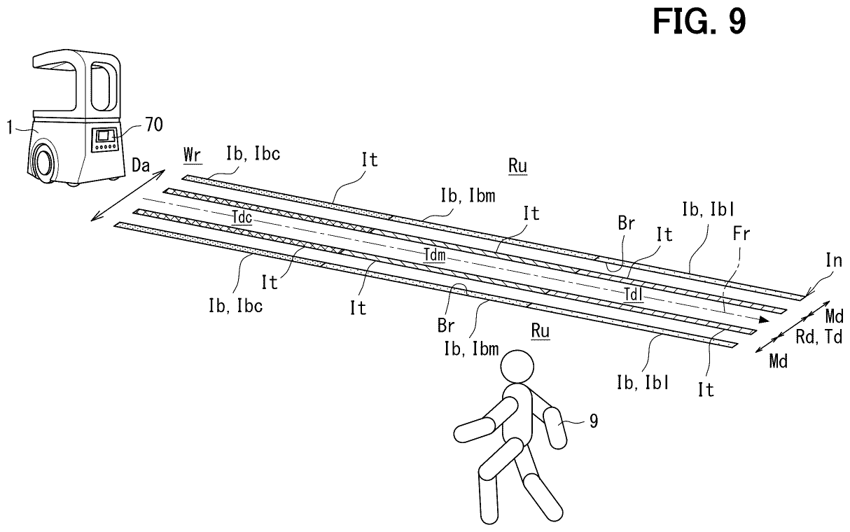

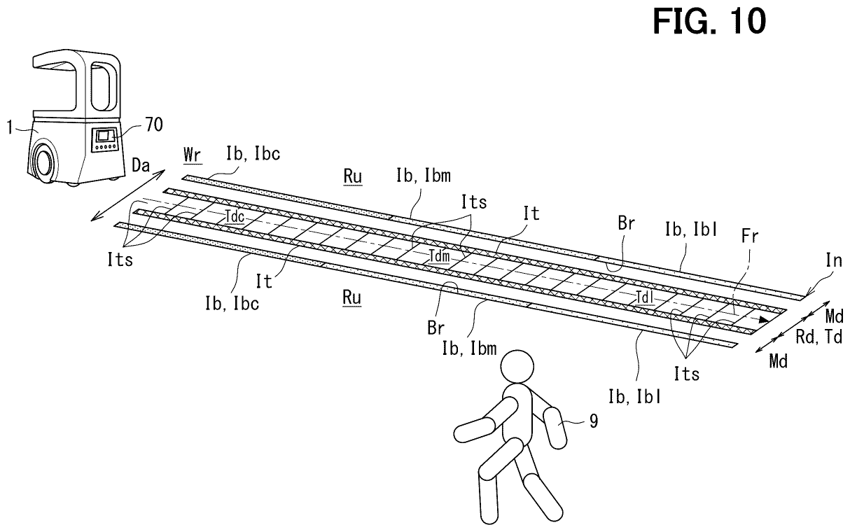

On the other hand, the trajectory image It may be a linear image of two lines extending in a direction along the planned driving route Fr as shown in FIGS. 8 to 10. The trajectory image It is projected to be aligned to both side edges of the planned trajectory Td. Here, as shown in FIG. 8, the linear image of the trajectory image It has a color that is substantially constant regardless of the distance sections Tdl, Tdm, and Tdc while the distance images Ibl, lb, and Ibc have different colors as display modes. The linear image of the trajectory image It may have different colors corresponding to the distance sections Tdl, Tdm, and Tdc of the planned trajectory Td as shown in FIG. 9, similarly to the boundary image Ib. The trajectory image It may include scale images Its as divisional lines along the width direction Da as shown in FIG. 10 (a modified example of FIG. 8) The divisional lines of the scale images Its indicate divisions on the planned driving route Fr at predetermined intervals from the autonomous driving device 1.

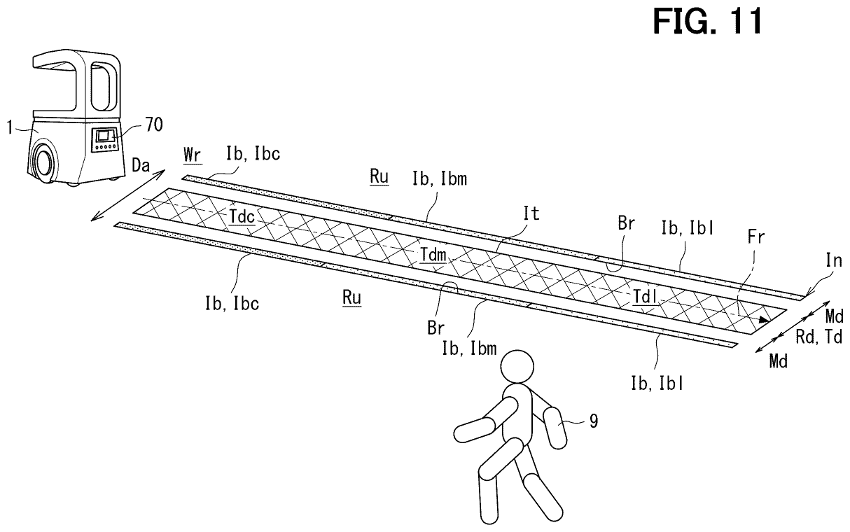

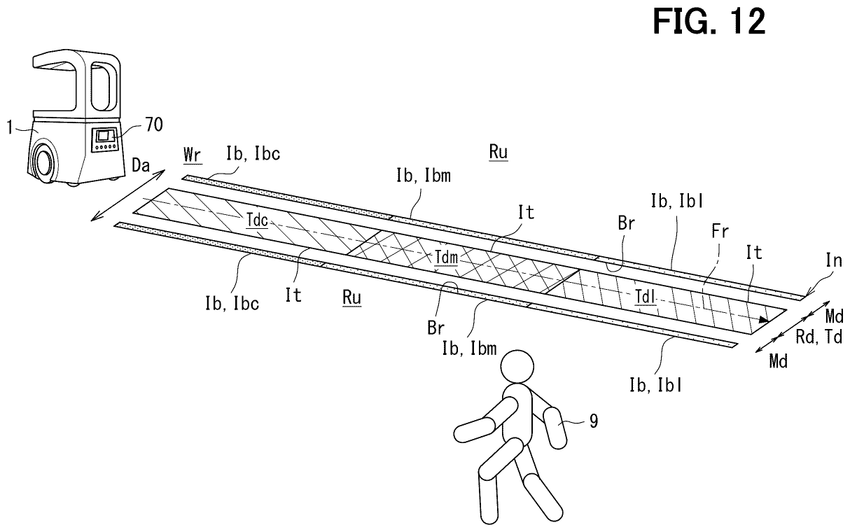

The trajectory image It may have a belt-shaped image extending along the planned driving route Fr as shown in FIGS. 11 and 12. The belt-shaped image of the trajectory image It is projected onto the range between both side edges of the planned trajectory Td. Here, the belt-shaped image of the trajectory image It has a substantially constant color regardless of the distance sections Tdl, Tdm, and Tdc while the distance images Ibl, Ibm, and Ibc have different colors as display modes as shown in FIG. 11. The belt-shaped image of the trajectory image It may have different colors according to the distance sections Tdl, Tdm, and Tdc as shown in FIG. 12, similarly to the boundary image Ib.

In the processing flow shown in FIG. 6, S107 is executed after S106. In S107, the projection block 110 causes the projector unit 70 to project the notification image In including the boundary image Ib and the trajectory image It as any one of FIGS. 8 to 12 onto the driving road Wr along the planned driving route Fr. At this time, the notification image In should be aligned in the width direction Da with respect to the driving road Wr with a position correction or a projection direction adjustment of the projector unit 70. Accordingly, it is preferable that the position of the notification image In is corrected on the driving road Wr according to the distance from the autonomous driving device 1.

The projection of the notification image In in S107 may be carried out only when the other road user is present in the moving allowable area Ru determined in S106. In other words, in S107, the projection of the notification image In is stopped when the other road user 9 does not exist in the moving allowable area Ru determined in S106, thereby reducing power consumption in the battery 32. Here, the presence or absence of the other road user 9 in the moving allowable area Ru is determined based on various types of information such as sensing information by the external sensor 40, communication information received from the external center through the communication system 5, and map information of the map database 6. As described above, upon completion of the execution of S107, the current execution of the processing flow ends.

(Effects) The actions and effects of the first embodiment described above are described below.

In the first embodiment, the planned driving route Fr of the autonomous driving device 1 is acquired. The notification image In is projected on the driving road Wr along the planned driving route Fr. The notification image In includes the boundary image Ib that indicates the boundary Br of the moving allowable area Ru where another road user is allowed to move. The boundary faces a driving area Rd where the autonomous driving device travels according to the planned driving route. With the notification image In including the boundary image Ib, the other road user 9 can recognize not only the driving area Rd in which the autonomous driving device 1 plans to travel but also the moving allowable area Ru in which the other road user 9 is allowed to move based on actions of the autonomous driving device 1 within the driving area Rd. Thus, it is possible to allow the other road user 9 to feel reassured about future actions of the autonomous driving device 1. Such effects achieved by the first embodiment is particularly effective in the driving road Wr, where a driving zone for the autonomous driving device 1 is not separated from a walking zone for pedestrians as the other road user 9.

According to the notification image In in the first embodiment, the boundary image Ib is located outside the trajectory image It in the width direction Da of the driving road Wr. The trajectory image It indicates the planned trajectory Td followed by the autonomous driving device 1 according to the planned driving route Fr as the driving area Rd. As a result, the other road user 9 can intuitively recognize, from the boundary image Ib, the moving allowable area Ru in which the other road user 9 is allowed to move according to actions of the autonomous driving device 1 in the driving area Rd. That is, the other road user 9 can directory recognize, from the trajectory image It, the driving area Rd of the autonomous driving device 1. Further, the other road user 9 can intuitively recognize, from the boundary image It located outside the trajectory image It in the width direction Da, the moving allowable area Ru where the other road user is allowed to move according to the behavior of the autonomous driving device 1 in the driving area Rd. Thus, it is possible to accurately provide a sense of reassurance about the future actions of the autonomous driving device 1 with the other road user 9.

In the notification image In according to the first embodiment, the boundary image Ib is projected at a position spaced from the side edge of the trajectory image It in the width direction Da by the margin range Md. As a result, the other road user 9 can intuitively recognize the moving allowable area Ru from the boundary image Ib, which is spaced outward from the driving area Rd by the margin range Rd according to actions of the autonomous driving device 1 within the driving area Rd, which is directory recognized from the trajectory image It. Thus, it is possible to secure a sense of reassurance about the future actions of the autonomous driving device 1.

In the notification image In according to the first embodiment, the boundary image Ib, in which the display mode changes according to the distance from the autonomous driving device 1 on the planned driving route Fr, is projected. As a result, the other road user 9 can intuitively recognize where in the moving allowable area Ru is more safe from the change in the display mode of the boundary image Ib corresponding to the distance from the autonomous driving device 1. The boundary image Ib is projected outside the driving area Rd of the autonomous driving device 1 that can be directory recognized from the trajectory image It. Thus, it is possible to increase a sense of reassurance about future actions of the autonomous driving device 1.

In the notification image In according to the first embodiment, the trajectory image It includes divisional lines at predetermined intervals from the autonomous driving device 1 along the planned driving route Fr. As a result, the other road user 9 can intuitively recognize where in the moving allowable area Ru is more safe not only from changes in the display mode of the boundary image Ib according to the distance from the autonomous driving device 1 within the driving area Rd but also from the divisional lines of the trajectory image It inside the boundary image Ib in the width direction Da. Thus, it is possible to increase a sense of reassurance about future actions of the autonomous driving device 1.

The boundary image Ib in the notification image according to the first embodiment includes the long-distance image Ibl that indicates the long-distance section Tdl in which the autonomous driving device 1 can change the driving plan on the planned driving route Fr in response to the other road user 9 entering the driving area Rd. As a result, the other road user 9 can intuitively recognize, from the long-distance image Ibl, the long-distance section Tdl as the driving area Rd in which the autonomous driving device 1 can avoid the other road user 9 by changing the driving plan of the autonomous driving device 1.

The boundary image Ib of the notification images according to the first embodiment includes the medium-distance image Ibm that indicates the medium-distance section Tdm closer to the autonomous driving device 1 than the long-range region Tdl is. The medium-distance section is an area in which the autonomous driving device 1 can brake in response to the other road user 9 entering the driving area Rd. As a result, the other road user 9 can intuitively recognize, from the medium-distance image Ibm, the medium-distance section Tdm as the driving area Rd in which the autonomous driving device 1 can avoid the other road user 9 by braking of the autonomous driving device 1.

The boundary image Ib of the notification image In according to the first embodiment includes the short-range image Ibc that indicates the short-distance section Tdc closer to the autonomous driving device 1 than the long-distance section Tdl and the medium-distance section Tdm are. As a result, the other road user 9 can intuitively recognize, from the short-distance image Ibc, the short-distance section Tdc as the driving area Rd.

The long-distance image Ibl, the medium-distance image Ibm, and the short-distance image Ibc of the boundary image Ib according to the first embodiment have different display modes according to the distance from the autonomous driving device 1 on the planned driving route Fr. As a result, the other road user 9 can distinguish and recognize the long-distance section Tdl, the medium-distance section Tdm, and the short-distance section Tdc from the difference of the display mode in the boundary image Ib. Thus, it is possible to secure a high degree of reassurance about future actions of the autonomous driving device 1.

According to the first embodiment, the length of the linear image as the boundary image Ib of the notification image In increases in the width direction Da as the flatness of the road surface of the driving road Wr decreases. Generally, it becomes more difficult to project the linear image as the boundary image Ib clearly onto the driving road Wr as the flatness of the driving road Wr decreases. However, according to the first embodiment described above, the length of the linear image of the boundary image Ib in the width direction Da increases based on the flatness of the surface of the driving road Wr, thereby avoiding unclear projection of the linear image of the boundary image Ib. Thus, it is possible to accurately provide a sense of reassurance about the future actions of the autonomous driving device 1.

The length of the linear image as the boundary image Ib increases in the width direction Da as the brightness of the surface of the driving road Wr decreases. Generally, it becomes more difficult to project the linear image as the boundary image Ib clearly onto the driving road Wr as the brightness of the driving road Wr decreases. However, according to the first embodiment described above, the linear image as the boundary image Ib increases in the width direction Da based on the brightness of the surface of the driving road Wr, thereby avoiding unclear projection of the linear image as the boundary image Ib. Thus, it is possible to accurately provide a sense of reassurance about the future actions of the autonomous driving device 1.

(Second Embodiment) A second embodiment is a modification to the first embodiment.

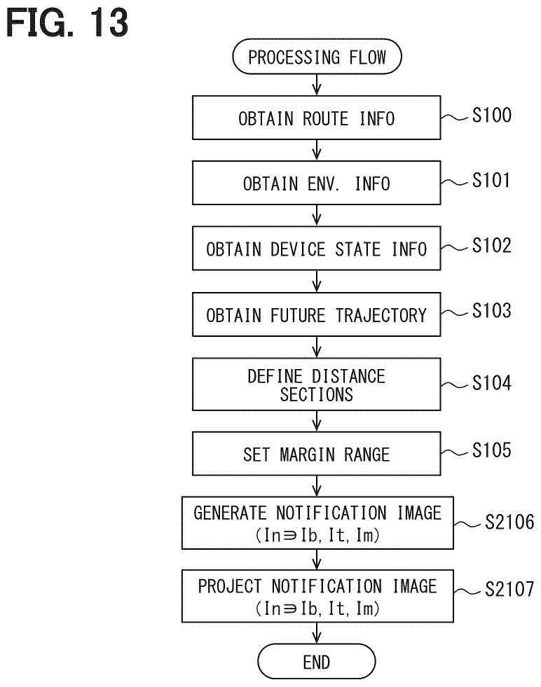

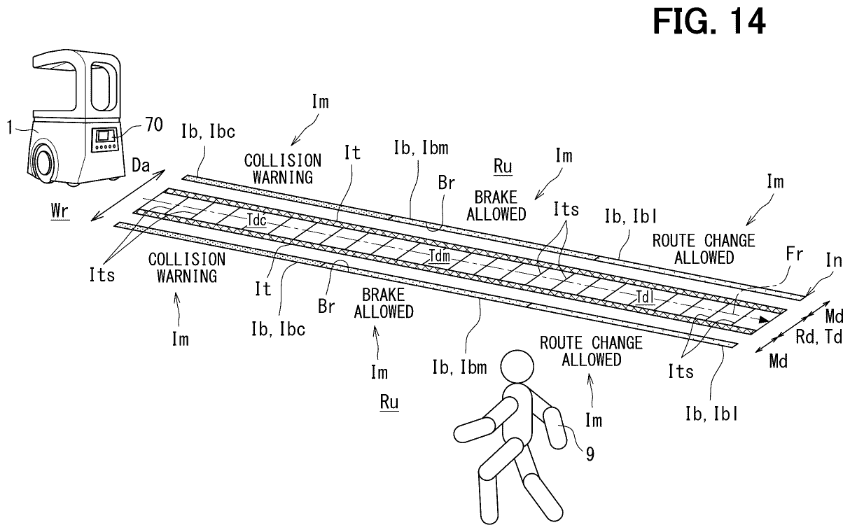

As shown in FIGS. 13, S2106 and S2107 are executed instead of S106 and S107 described above in the processing flow of the second embodiment. In S2106, the projection block 110 generates a notification image In including a message image Im in the moving allowable area Ru. In S2107, the notification image In including the massage image is projected. The message image Im is projected on at least one of the outer sides of the boundary image Ib, which is located on both sides of the trajectory image It in the width direction Da. FIG. 14 shows an example where the massage image Im in the notification image In is projected on both sides of the boundary image Ib, which is located on both sides of the trajectory image It in the width direction Da as shown in FIG. 10 of the first embodiment.

The message image Im is generated so that messages respectively for the long-distance image Ibl, the medium-distance image Ibm, and the short-distance image Ibc are displayed separately for the long-distance image Ibl, the medium-distance image Ibm, and the short-distance image Ibc in order to notify the other road user 9 of the messages. At this time, the long-distance image Ibl has the message of words projected on the side of the long-distance section Tdl. Thus, the long-distance section is indicated by the massages as an area where the autonomous driving device 1 can change the driving plan on the planned driving route Fr in response to the other road user 9 entering the planned trajectory Td. The medium-distance image Ibm has the message of words projected on the side of the medium-distance section Tdm. Thus, the medium distance section is indicated by the massages as an area where the autonomous driving device 1 can brake in response to the other road user 9 entering the planned trajectory Td. The short-distance image Ibc has the messages of words projected on the side of the short-distance section Tdc. Thus, the short distance section is indicated by the massages as a caution area.

The message image Im indicates messages for at least one of the trajectory image It and the boundary image Ib when the message image Im is applied to FIG. 10 in the first embodiment as in FIG. 14 and the message image is applied to FIGS. 8, 9, 11, and 12 (not illustrated). The other parts of S2106 described above is executed in the same manner as S106 in the first embodiment. As a result, at S2107 in the second embodiment, the notification image In including the message image Im, the boundary image Ib, and the trajectory image It generated in S2106 is projected as shown in FIG. 14.

According to the second embodiment described above, the notification image In is projected such that the message image Im, which indicates messages respectively for the long-distance image Ibl, the medium-distance image Ibm, and the short-distance image Ibc, is projected on the outer side of the boundary image Ib in the width direction Da to notify the other road user 9 of the messages. As a result, the other road user 9 can directly recognize the meanings of the distance images Ibl, Ibm, and Ibc from the messages in the message image Im projected on the outer range of the boundary image Ib, which indicates the limit of the moving allowable area Ru recognized by the other road user 9 intuitively from the boundary image Ib. Thus, it is possible to increase a sense of reassurance about future actions of the autonomous driving device 1.

From another point of view, according to the second embodiment, the notification image In is projected to display the message image Im, which notifies the other road user 9 of messages for at least one of the trajectory image It and the boundary image Ib, outside the boundary image Ib in the width direction Da. As a result, the other road user 9 can directly recognize the meanings of the trajectory image It and the boundary image Ib from the messages in the message image Im projected on the outer range of the boundary image Ib, which indicates the limit of the moving allowable area Ru recognized by the other road user intuitively from the boundary image Ib. Thus, it is possible to increase a sense of reassurance about future actions of the autonomous driving device 1.

(Other embodiments) Although multiple embodiments have been described above, the present disclosure is not limited to these embodiments, and can be applied to various embodiments and combinations within a scope that does not depart from the gist of the present disclosure.

In another modification, a dedicated computer constituting the processing system 10 may include at least one of a digital circuit or an analog circuit, as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

In the notification image In of the modified example, the color as the display mode of the boundary image Ib may be set substantially constant among the distance sections Tdl, Tdm, and Tdc of the planned trajectory Td. In the notification image In of the modified example, the trajectory image It may be omitted. In the notification image In of the modified example, the components of the color as the display mode, such as brightness and saturation, may be adjusted according to the change of the color of the surface of the driving road Wr. In the notification image In of the modified example, the message image Im that indicates messages for the driving state of the autonomous driving device 1 may be displayed in the moving allowable area Ru. In the notification image In of the modified example, when the autonomous driving device 1 is applied to the package transporting robot, the message image Im that indicates a message representing at least one of, for example, the type of transporting packages and the attention to the transporting packages may be displayed in the moving allowable area Ru. In the modified example, the contents of the message in the message image Im may be notified by an audio from the information presentation system 7 of the hearing stimulation type.

In addition to the above-described embodiments and modifications, the present disclosure may be implemented in forms of a processing device that includes at least one processor 12 and at least one memory 11 and is mountable in the autonomous driving device 1, such as a processing circuit (e.g., a processing ECU) or a semiconductor device (e.g., a semiconductor chip). Furthermore, the embodiments and the modified examples described above may of course be implemented as an autonomous driving device 1 equipped with such a processing device.

1. A processing system for performing processing regarding autonomous driving of an autonomous driving device, the processing system comprising
a processor configured to:
obtain a planned driving route of the autonomous driving device; and
project a notification image onto a road along the planned driving route, wherein
the notification image includes:
a boundary image that indicates a boundary of a moving allowable area where an other road user is allowed to move, the boundary facing a driving area where the autonomous driving device travels according to the planned driving route; and
a trajectory image that indicates, as the driving area, a planned trajectory that the autonomous driving device follows according to the planned driving route,
the boundary image is located outside the trajectory image in a width direction of the road, and
the boundary image has different display modes depending on a distance from the autonomous driving device on the planned driving route.

2. The processing system according to claim 1, wherein
the boundary image is spaced from a side edge of the trajectory image in the width direction by a margin range.

3. The processing system according to claim 1, wherein
the trajectory image has divisional lines on the planned driving route at predetermined intervals from the autonomous driving device.

4. The processing system according to claim 1, wherein
the boundary image includes:
a long-distance image that indicates a long-distance section where the autonomous driving device is allowed to change a travelling plan of the autonomous driving device on the planned driving route in response to the other road user entering the driving area;
a medium-distance image that indicates a medium-distance section where the autonomous driving device is allowed to brake in response to the other road user entering the driving area, the medium-distance section being closer to the autonomous driving device than the long-distance section is; and
a short-distance image that indicates a short-distance section that is closer to the autonomous driving device than the medium-distance section is, and
the long-distance image, the medium-distance image, and the short-distance image have different display modes.

5. The processing system according to claim 4, wherein
the notification image further includes a message image outside the boundary image in the width direction, and
the message image indicates messages for the other road user relating to the long-distance image, the medium-distance image, and the short-distance image, respectively.

6. The processing system according to claim 1, wherein
the notification image includes a message image outside the boundary image in the width direction, and
the message image indicates a message for the other road user relating to at least one of the trajectory image or the boundary image.

7. The processing system according to claim 1, wherein
the boundary image is a linear image, and
a length of the linear image in the width direction increases as a flatness of a surface of the road decreases.

8. The processing system according to claim 1, wherein
the boundary image is a linear image, and
a length of the linear image in the width direction increases as a brightness of a surface of the road decreases.

9. A processing device to be mounted in an autonomous driving device for performing processing regarding autonomous driving of the autonomous driving device, the processing device comprising
a processor configured to:
obtain a planned driving route of the autonomous driving device; and
project a notification image onto a road along the planned driving route, wherein
the notification image includes:
a boundary image that indicates a boundary of a moving allowable area where an other road user is allowed to move, the boundary facing a driving area where the autonomous driving device travels according to the planned driving route; and
a trajectory image that indicates, as the driving area, a planned trajectory that the autonomous driving device follows according to the planned driving route,
the boundary image is located outside the trajectory image in a width direction of the road, and
the boundary image has different display modes depending on a distance from the autonomous driving device on the planned driving route.

10. An autonomous driving device comprising
the processing device according to claim 9.

11. A processing method executed by a processor for performing processing regarding autonomous driving of an autonomous driving device, the processing method comprising:
obtaining a planned driving route of the autonomous driving device; and
projecting a notification image onto a road along the planned driving route, wherein
the notification image includes:
a boundary image that indicates a boundary of a moving allowable area where an other road user is allowed to move, the boundary facing a driving area where the autonomous driving device travels according to the planned driving route; and
a trajectory image that indicates, as the driving area, a planned trajectory that the autonomous driving device follows according to the planned driving route,
the boundary image is located outside the trajectory image in a width direction of the road, and
the boundary image has different display modes depending on a distance from the autonomous driving device on the planned driving route.

12. A non-transitory computer readable storage medium storing a processing program for performing processing regarding autonomous driving of an autonomous driving device, the processing program including instructions when executed by a processor cause the processor to:
obtain a planned driving route of the autonomous driving device; and
project a notification image onto a road along the planned driving route, wherein
the notification image includes:
a boundary image that indicates a boundary of a moving allowable area where an other road user is allowed to move, the boundary facing a driving area where the autonomous driving device travels according to the planned driving route; and
a trajectory image that indicates, as the driving area, a planned trajectory that the autonomous driving device follows according to the planned driving route,
the boundary image is located outside the trajectory image in a width direction of the road, and
the boundary image has different display modes depending on a distance from the autonomous driving device on the planned driving route.
